(19) United States
(12) Patent Application Publication
(10) Pub. No.: US 2026/0281997 A1
(43) Pub. Date: Sep. 17, 2026

(54) DEVICES AND METHODS OF COMMUNICATION

(71) Applicant: LENOVO (BEIJING) LIMITED, Beijing (CN)

(72) Inventors: Ran YUE, Beijing (CN); Lianhai WU, Beijing (CN); Jing HAN, Beijing (CN); Min XU, Beijing (CN)

(21) Appl. No.: 19/168,533

(22) PCT Filed: Jul. 5, 2023
(86) PCT No.: PCT/CN2023/105952

§ 371 Date: Sep. 24, 2025

(51) Int. Cl. H04W 72/0453; H04W 68/00

(52) U.S. Cl. CPC H04W 72/0453; H04W 68/005

(57) ABSTRACT

Various aspects of the present disclosure relate to devices and methods of communication. A base station transmits, to a UE, a configuration comprising information for evaluating validity of a resource for SDT. Based on the information, the UE determines the validity of the resource. In this way, a valid resource may be determined for SDT, and communication efficiency may be improved.

### TECHNICAL FIELD

The present disclosure relates to wireless communications, and more specifically to devices and methods of communication for small data transmission (SDT).

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Currently, SDT in an inactive state or an idle state has been approved so as to save signaling overhead. Further, it has been agreed to support mobile originating-SDT (MO-SDT) and mobile terminating-SDT (MT-SDT) procedures.

### SUMMARY

The present disclosure relates to methods, apparatuses, and systems that support evaluation of a resource for SDT. By receiving a configuration comprising information for evaluating validity of the resource, a communication device may determine a valid resource for SDT based on the information. In this way, communication efficiency may be improved.

In one aspect, some implementations of the method and apparatuses described herein may include receiving, from a base station, a configuration comprising information for evaluating validity of a resource for a small data transmission; and determining the validity of the resource based on the information.

In some implementations of the method and apparatuses described herein, the information comprises at least one of the following: a set of radio bearers, an operation associated with network energy saving, a threshold for determination of the validity of the resource, or a reference value for determination of the validity of the resource.

In some implementations of the method and apparatuses described herein, the threshold is associated with at least one of the following: a radio bearer, a set of data radio bearers for the small data transmission, a set of signaling radio bearers for the small data transmission, a logic channel, or a logic channel group.

In some implementations of the method and apparatuses described herein, determining the validity of the resource comprises determining a time interval between a first time point associated with the resource and a reference time point; in accordance with a determination that the time interval is below a threshold, determining that the resource is valid; and in accordance with a determination that the time interval is above the threshold, determining that the resource is invalid.

In some implementations of the method and apparatuses described herein, the reference time point is one of the following: a time point that a paging message associated with the small data transmission is received, a time point that a response to the paging is initiated, a time point that a resume procedure is initiated for the small data transmission, or a time point that data associated with the small data transmission arrives.

In some implementations of the method and apparatuses described herein, the threshold is a latency requirement of a radio bearer in a set of radio bearers for the small data transmission.

In some implementations of the method and apparatuses described herein, the information comprises a set of thresholds associated with a set of radio bearers. These implementations of the method and apparatuses described herein may further include receiving a paging message comprising an indication of a radio bearer associated with the small data transmission in the set of radio bearers and determining, from the set of thresholds, the threshold associated with the radio bearer.

In some implementations of the method and apparatuses described herein, the threshold is a timer value or a time window configured by the base station.

In some implementations of the method and apparatuses described herein, the first time point is a preamble transmission occasion associated with the resource.

In some implementations of the method and apparatuses described herein, the threshold is a second time point associated with a configured grant resource for the small data transmission, the configured grant resource being invalid.

In some implementations of the method and apparatuses described herein, the first time point is determined based on an uplink data transmission occasion during a random access procedure.

In some implementations of the method and apparatuses described herein, the uplink data transmission occasion is determined based on a preamble transmission occasion associated with the resource and a reference value.

In some implementations of the method and apparatuses described herein, the reference value is determined based on at least one of the following: a random access response window, a round trip time value, a duration from reception of a downlink scheduling signal to reception of an uplink grant, a duration from transmission of a preamble to the reception of the downlink scheduling signal, or a processing delay.

In some implementations of the method and apparatuses described herein, determining the validity of the resource comprises at least one of the following: in accordance with a determination that the resource has no overlap with a duration in which no transmission or reception is performed by the base station, determining that the resource is valid; or in accordance with a determination that the resource overlaps with the duration in which no transmission or reception is performed by the base station, determining that the resource is invalid.

In some implementations of the method and apparatuses described herein, determining the validity of the resource comprises: determining an allowed uplink data transmission duration associated with a radio bearer in a set of radio bearers for the small data transmission; in accordance with a determination that an uplink data transmission duration associated with the resource is below the allowed uplink data transmission duration associated with the radio bearer, determining that the resource is valid; and in accordance with a determination that the uplink data transmission duration associated with the resource is above the allowed uplink data transmission duration associated with the radio bearer, determining that the resource is invalid.

Some implementations of the method and apparatuses described herein may further include selecting a first carrier for initiating the small data transmission; and in accordance with a determination that no resources on the first carrier are valid and a resource on a second carrier is valid, performing a carrier reselection to the second carrier.

In another aspect, some implementations of the method and apparatuses described herein may include transmitting, to a user equipment, a configuration comprising information for evaluating validity of a resource for a small data transmission.

In some implementations of the method and apparatuses described herein, the information may comprise at least one of the following: a set of radio bearers, an operation associated with network energy saving, a threshold for determination of the validity of the resource, or a reference value for determination of the validity of the resource.

In some implementations of the method and apparatuses described herein, the threshold may be associated with at least one of the following: a radio bearer, a set of data radio bearers for the small data transmission, a set of signaling radio bearers for the small data transmission, a logic channel, or a logic channel group.

In some implementations of the method and apparatuses described herein, the threshold may be a timer value or a time window configured by the base station.

In some implementations of the method and apparatuses described herein, the information may comprise a set of thresholds associated with a set of radio bearers. These implementations of the method and apparatuses described herein may further include: transmitting, to the user equipment, a paging message comprising an indication of a radio bearer associated with the small data transmission in the set of radio bearers.

### BRIEF DESCRIPTION OF THE DRAWINGS

FIG. 1 illustrates an example of a wireless communications system that supports evaluation of a resource for SDT in accordance with aspects of the present disclosure.

FIG. 2 illustrates an example of a process that supports evaluation of a resource for SDT in accordance with aspects of the present disclosure.

FIG. 3 illustrates an example of a device that supports evaluation of a resource for SDT in accordance with aspects of the present disclosure.

FIG. 4 illustrates an example of another device that supports evaluation of a resource for SDT in accordance with aspects of the present disclosure.

FIG. 5 illustrates an example of a processor that supports evaluation of a resource for SDT in accordance with aspects of the present disclosure.

FIG. 6 illustrates a flowchart of a method that supports evaluation of a resource for SDT in accordance with aspects of the present disclosure.

FIG. 7 illustrates a flowchart of another method that supports evaluation of a resource for SDT in accordance with aspects of the present disclosure.

### DETAILED DESCRIPTION

As known, a SDT procedure may be performed either by a random access (RA) procedure with 2-step RA type or 4-step RA type (i.e., RA-SDT) or by configured grant (CG) Type 1 (i.e., CG-SDT). For convenience, a CG resource configured for SDT may also be referred to as a CG-SDT resource, and an RA resource configured for SDT may also be referred to as an RA-SDT resource. An RA resource configured for UE may also be used for a SDT procedure.

Recently, it has been agreed that for both MO-SDT and MT-SDT, if a next CG-SDT resource is too far, an RA resource may be selected first. In the context of the present disclosure, the term “too far” may means that an available resource is far away from arrival data and the arrival data cannot be transmitted in time, or a parameter (e.g. a subcarrier spacing (SCS), a physical uplink shared channel (PUSCH) duration, etc.) of a CG-SDT resource is not suitable for data transmission. The arrival data may be uplink (UL) data or downlink data (DL) data. In the context of the present disclosure, if a resource is too far, the resource is considered as being invalid. Otherwise, the resource is considered as being valid.

However, it is still unclear how to determine whether a CG-SDT resource is too far. It is also unclear how to determine whether an RA-SDT resource is too far.

In view of this, embodiments of the present disclosure provide a solution of evaluating validity of a resource for SDT. In the solution, a base station transmits, to a UE, a configuration comprising information for evaluating validity of a resource for SDT. Based on the information, the UE determines the validity of the resource.

In this way, by determining validity of a resource for SDT based on information for evaluating the validity of the resource comprised in a configuration, a communication device may determine a valid resource for SDT, and thus improve communication efficiency.

Aspects of the present disclosure are described in the context of a wireless communications system.

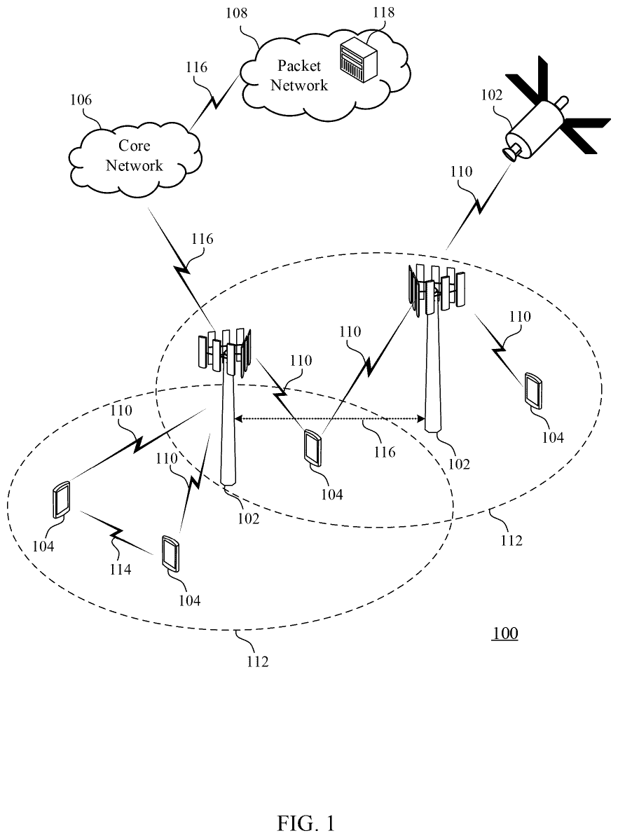

FIG. 1 illustrates an example of a wireless communications system 100 that supports evaluation of a resource for SDT in accordance with aspects of the present disclosure. The wireless communications system 100 may include one or more network entities 102 (also referred to as network equipment (NE)), one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IOT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In the context of the present disclosure, the term “a connected state” may be interchangeably used with “an RRC_CONNECTED state”, the term “an idle state” may be interchangeably used with “an RRC_IDLE state”, and the term “an inactive state” may be interchangeably used with “an RRC_INACTIVE state”.

In some scenarios, the UE 104 may enter an inactive state or an idle state. In some embodiments where the UE 104 is in the inactive or idle state, small and infrequency UL data may arrive at the UE 104. The UE 104 may perform a SDT procedure to transmit the UL data to the network entity 102. This procedure is a MO-SDT procedure.

In some embodiments where the UE 104 is in the inactive or idle state, the network entity 102 may transmit a paging message for the UE 104. The paging message may be associated with SDT. In other words, the paging message may indicate the SDT. Upon reception of the paging message, the UE 104 may transmit, to the network entity 102, a response to the paging message. The network entity 102 may transmit DL data to the UE 104 while the UE 104 maintains in the inactive state or the idle state. This procedure is a MT-SDT procedure.

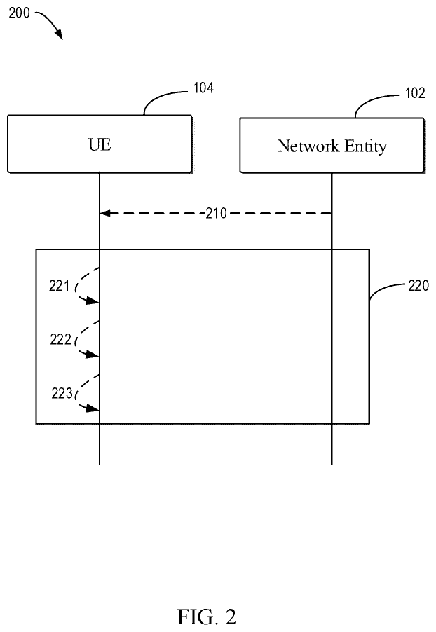

Embodiments of the present disclosure provide a solution of evaluating validity of a resource for SDT. The solution may apply to both MO-SDT and MT-SDT procedures. The solution will be described in connection with FIG. 2 below.

FIG. 2 illustrates an example of a process 200 that supports evaluation of a resource for SDT in accordance with aspects of the present disclosure. For the purpose of discussion, the process 200 will be described with reference to FIG. 1. The process 200 may involve the UE 104 and the network entity 102 as illustrated in FIG. 1. It is to be understood that the steps and the order of the steps in FIG. 2 are merely for illustration, and not for limitation.

As shown in FIG. 2, the network entity 102 may transmit 210, to the UE 104, a configuration comprising information for evaluating validity of a resource for SDT. In some embodiments, the configuration may be transmitted when the UE 104 is in a connected state. In some embodiments, the configuration may be transmitted when the UE 104 is released to an inactive state or an idle state. In some embodiments, the configuration may be updated when the UE 104 is in the inactive state or the idle state.

In some embodiments, the information may be included in an RRCReconfiguration message. In some embodiments, the information may be included in an RRCRelease message including suspendConfig. In some embodiments, the information may be included in an information element (IE) sdt-Config.

In some embodiments, the information may comprise a set of radio bearers (RBs), i.e., one or more RBs. In some embodiments, the network entity 102 may configure, to the UE 104, the set of RBs for SDT. That is, the set of RBs is associated with SDT. In some embodiments, an RB in the set of RBs may be a signal radio bearer (SRB). In some embodiments, an RB in the set of RBs may be a data radio bearer (DRB).

In some embodiments, the information may comprise an operation associated with network energy saving (NES). In some embodiments, the network entity 102 may configure, to the UE 104, a NES related configuration. In some embodiments, the NES related configuration may be a cell discontinuous transmission (DTX) configuration. In some embodiments, the NES related configuration may be a cell discontinuous reception (DRX) configuration. In some embodiments, the information may comprise a duration in which no transmission or reception is performed by the network entity 102, e.g., a cell DRX off duration or a cell DTX off duration.

In some embodiments, the information may comprise a threshold for determination of the validity of the resource. In some embodiments, the threshold may be associated with an RB. In other words, the threshold may be configured per RB. In some embodiments, the information may comprise a set of thresholds associated with a set of RBs.

In some embodiments, the threshold may be associated with a logic channel (LCH). In other words, the threshold may be configured per LCH. In some embodiments, the information may comprise a set of thresholds associated with a set of LCHs.

In some embodiments, the threshold may be associated with a logic channel group (LCG). In other words, the threshold may be configured per LCG. In some embodiments, the information may comprise a set of thresholds associated with a set of LCGs.

In some embodiments, the threshold may be associated with a set of DRBs for SDT (also referred to as a set of SDT-DRBs herein). In other words, the threshold may be a common threshold for all of the SDT-DRBs. In some embodiments, the threshold may be associated with a set of SRBs for SDT (also referred to as a set of SDT-SRBs herein). In other words, the threshold may be a common threshold for all of the SDT-SRBs. In some embodiments, the threshold may be associated with a set of RBs for SDT (also referred to as a set of SDT-RBs herein).

In some embodiments, the information may comprise a reference value for determination of the validity of the resource. The reference value may be used for determination of an uplink data transmission (e.g., PUSCH) occasion during an RA procedure.

It is to be understood that the information for evaluating the validity of the resource for SDT may include any combination of the above information. In some alternative embodiments, the information for evaluating the validity of the resource for SDT may be predefined.

Continuing to refer to FIG. 2, the UE 104 may determine 220 validity of a resource for SDT based on the information. With reference to FIG. 2, the UE 104 may determine 221 that a SDT is to be performed. In some embodiments, UL data associated with the SDT may arrive at the UE 104. In this case, the UE 104 may trigger a MO-SDT procedure. In some embodiments, the UE 104 may receive, from the network entity 102, a paging message associated with the SDT. That is, a MT-SDT procedure may be triggered.

In some embodiments, the SDT may include an initial transmission of the SDT. In some embodiments, the SDT may include a subsequent transmission of the SDT.

With reference to FIG. 2, upon determination that the SDT is to be performed, the UE 104 may select 222 a resource for the SDT. The UE 104 may use the resource to transmit the UL data in the MO-SDT procedure or transmit the response to the paging message in the MT-SDT procedure.

In some embodiments, the UE 104 may select a CG-SDT resource for the SDT. In some embodiments, the UE 104 may select an RA-SDT resource for the SDT. In some embodiments, the UE 104 may select a non-SDT RA resource for the SDT. It is to be understood that the selection may be carried out in any suitable ways existing or to be developed in future, and the present disclosure does not limit this aspect.

Continuing to refer to FIG. 2, the UE 104 may determine 223 whether the selected resource is valid, i.e., evaluate validity of the selected resource. If the selected resource is valid, the UE 104 may use the selected resource for the SDT.

In some embodiments for validity evaluation, the UE 104 may determine a time interval between a time point (for convenience, also referred to as a first time point herein) associated with the selected resource and a reference time point. In some embodiments, the reference time point may be a time point that a paging message associated with the SDT is received. In some embodiments, the reference time point may be a time point that a response to the paging message is initiated. In some embodiments, the reference time point may be a time point that a resume procedure is initiated for the SDT. In some embodiments, the reference time point may be a time point that data associated with the SDT arrives.

In some embodiments, if the time interval is below (i.e., smaller than or equal to) a threshold, the UE 104 may determine that the selected resource is valid. In some embodiments, if the time interval is above (i.e., larger than or equal to) the threshold, the UE 104 may determine that the selected resource is invalid. In other words, if the selected resource is farther than a sum of the reference time point and the threshold, the UE 104 may determine that the selected resource is invalid.

In some embodiments, the threshold may be configured. In some embodiments, the threshold may be predefined.

In some embodiments where a set of thresholds associated with a set of RBs are configured or predefined, the UE 104 may receive, from the network entity 102, a paging message comprising an indication of an RB associated with the SDT in the set of RBs. The paging message may be associated with the SDT or indicate the SDT. Based on the indication of the RB, the UE 104 may determine, from the set of thresholds, the threshold associated with the indicated RB. In some embodiments, the UE 104 may receive, from the network entity 102, a paging message comprising an indication of one or more values or thresholds. The paging message may be associated with the SDT or indicate the SDT. Based on the indication of the one or more values or thresholds, the UE 104 may select one from the one or more values or thresholds as the threshold associated with the indicated SDT.

In some embodiments, the threshold may be a latency requirement of an RB in a set of RBs for the SDT. In some embodiments, the threshold may be the most critical latency requirement among all of the set of RBs. In some embodiments, the threshold may be the most critical latency requirement among all of the configured SDT DRBs. In some embodiments, the threshold may be associated with a requirement of an RB in the set of RBs with the highest priority. In some embodiments, the threshold may be a latency requirement of an RB in the set of RBs with the highest priority. In some embodiments, the threshold may be the shortest remaining time among pending or buffered or arrival data to be transmitted by the UE 104. In some embodiments, the threshold may be the most critical latency requirement among DL data to be transmitted by the network entity 102.

In some embodiments, the threshold may be a latency requirement of an LCH in a set of LCHs for the SDT. In some embodiments, the threshold may be the most critical latency requirement among all of the configured SDT LCHs. In some embodiments, the threshold may be associated with a requirement of an LCH in the set of LCHs with the highest priority. In some embodiments, the threshold may be a latency requirement of an LCH in the set of LCHs with the highest priority. In some embodiments where a set of thresholds associated with a set of LCHs are configured or predefined, the UE 104 may receive, from the network entity 102, a paging message comprising an indication of an LCH associated with the SDT in the set of LCHs. Based on the indication of the LCH, the UE 104 may determine, from the set of thresholds, the threshold associated with the indicated LCH.

In some embodiments, the threshold may be a time duration configured by the network entity 102. In some embodiments, the network entity 102 may configure a timer as the time duration. In some embodiments, the network entity 102 may configure a time window as the time duration. In some embodiments, the threshold may be a value of a timer configured by the network entity 102. In some embodiments, the UE 104 may determine that the selected resource is invalid if the timer expires before the selected resource.

In some embodiments, the UE 104 may determine that the selected resource is valid if a NES related configuration is not configured to the UE 104. In some embodiments, the UE 104 may determine that the selected resource is valid if the selected resource does not overlap with the NES related configuration. In some embodiments, if the selected resource has no overlap with a duration (e.g., cell DTX or DRX off duration) in which no transmission or reception is performed by the network entity 102, the UE 104 may determine that the selected resource is valid. In some embodiments, if the selected resource overlaps with the duration in which no transmission or reception is performed by the network entity 102, the UE 104 may determine that the selected resource is invalid.

In some embodiments, the UE 104 may determine that the selected resource is invalid if the timer expires before the selected resource (e.g., before a starting point of the selected resource in time-domain) and if a NES related configuration is not configured to the UE 104. In some embodiments, the UE 104 may determine that the selected resource is invalid if the selected resource overlaps with a NES related configuration and the next available SDT resource does not overlap with the NES related configuration and if the next available SDT resource which is the first resource that does not overlap with the NES related configuration is farther than a sum of the reference time point and the threshold.

In some embodiments, the UE 104 may determine an allowed uplink data transmission duration (e.g., maxPUSCH-Duration) associated with an RB in a set of RBs for the SDT. If an uplink data transmission (e.g., PUSCH) duration associated with the selected resource is below (i.e., smaller than or equal to) the allowed uplink data transmission duration associated with the RB, the UE 104 may determine that the selected resource is valid. If the uplink data transmission duration associated with the selected resource is above (i.e., larger than or equal to) the allowed uplink data transmission duration associated with the RB, the UE 104 may determine that the selected resource is invalid.

In some embodiments, the UE 104 may determine that the selected resource is invalid if maxPUSCH-Duration for logical channel(s) configured with SDT and data arrive at the logical channel(s) or for the highest priority logical channel among the logical channel(s) configured with SDT and data arrive at the logical channel(s), if configured, is smaller than the PUSCH transmission duration associated to the UL grant.

In some embodiments, the UE 104 may determine that the selected resource is invalid if the selected resource does not overlap with a NES related configuration and if the maxPUSCH-Duration for the logical channel(s) configured with SDT and data arrive at the logical channel(s) or for the highest priority logical channel among the logical channel(s) configured with SDT and data arrive at the logical channel(s), if configured, is smaller than the first PUSCH transmission duration associated to the UL grant.

In some embodiments, the UE 104 may determine that the selected resource is invalid if the selected resource overlaps with a cell DTX or DRX off duration and the next resource does not overlap with the cell DTX or DRX off duration and if the maxPUSCH-Duration for the logical channel(s) configured with SDT and data arrive at the logical channel(s) or for the highest priority logical channel among the logical channel(s) configured with SDT and data arrive at the logical channel(s), if configured, is smaller than the next PUSCH transmission duration associated to the UL grant.

In some embodiments, the UE 104 may determine that the selected resource is invalid if the selected resource is farther than a sum of the threshold and a time point for reception of paging for MT-SDT. In some embodiments, the UE 104 may determine that the selected resource is invalid if the selected resource overlaps with the NES related configuration and the next available SDT resource does not overlap with the NES related configuration and if the next available SDT resource which is the first available resource that does not overlap with the NES related configuration is farther than a sum of the threshold and the time point for reception of paging for MT-SDT.

In some embodiments, the UE 104 may determine that the selected resource is invalid if the selected resource is farther than a sum of the threshold and a time point that UL small data arrive or the lower layer receives the upper layer an indication of the UL small data arrival. In some embodiments, the UE 104 may determine that the selected resource is invalid if the selected resource overlaps with a NES related configuration and the next available SDT resource which does not overlap with the NES related configuration and if the next available SDT resource which is the first available resource that does not overlap with the NES related configuration is farther than a sum of the threshold and the time point for reception of paging for MT-SDT.

In some embodiments, the UE 104 may select a carrier (for convenience, also referred to as a first carrier herein) for initiating the SDT. If no resources on the first carrier are valid and a resource on another carrier (for convenience, also referred to as a second carrier herein) is valid, the UE 104 may perform a carrier reselection to the second carrier. In this way, the UE 104 may select the valid resource on the second carrier for the SDT.

In some embodiments, the first carrier may be a normal uplink (NUL) carrier, and the second carrier may be a supplementary uplink (SUL) carrier. In some embodiments, the first carrier and the second carrier may be NUL carriers. In some embodiments, the first carrier and the second carrier may be SUL carriers. In some embodiments, the first carrier may be an SUL carrier, and the second carrier may be a NUL carrier.

In some embodiments where the selected resource is an RA-SDT resource, validity of the RA-SDT resource may be carried out based on a preamble transmission (e.g., physical random access channel (PRACH)) occasion. In some embodiments, the first time point may be a preamble transmission occasion associated with the selected resource. In some embodiments, the threshold may be a second time point associated with an invalid CG resource for the SDT which is the next CG-SDT resource for SDT.

In some embodiments where the selected resource is an RA-SDT resource, validity of the RA-SDT resource may be carried out based on uplink data transmission (e.g., PUSCH) occasion during an RA procedure. In some embodiments, the first time point may be determined based on the uplink data transmission occasion during the RA procedure. In some embodiments, the uplink data transmission occasion may be determined based on a preamble transmission (e.g., PRACH) occasion associated with the selected resource and a reference value. In some embodiments, the reference value may be 0.

In some embodiments, the reference value may be determined based on a random access response (RAR) window. In some embodiments, the reference value may be determined based on a round trip time (RTT) value. In some embodiments, the reference value may be determined based on a duration (e.g., k2) from reception of a downlink scheduling signal to reception of an uplink grant. In some embodiments, the reference value may be determined based on a duration from transmission of a preamble to the reception of the downlink scheduling signal. In some embodiments, the reference value may be determined based on a processing delay (e.g., a delta value for the processing delay). It is to be understood that the reference value may be determined by any combination of the above information or by any other suitable ways.

So far, validity evaluation of a resource for SDT is described. With the process 200, a valid resource may be determined for SDT, and thus communication efficiency may be improved.

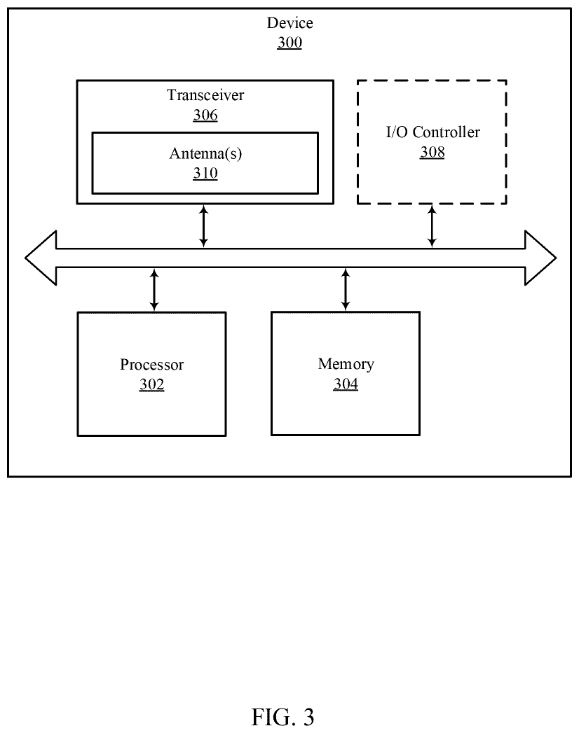

FIG. 3 illustrates an example of a device 300 that supports evaluation of a resource for SDT in accordance with aspects of the present disclosure. The device 300 may be an example of the UE 104 as described herein. The device 300 may support wireless communication with one or more network entities 102, UEs 104, or any combination thereof. The device 300 may include components for bi-directional communications including components for transmitting and receiving communications, such as a processor 302, a memory 304, a transceiver 306, and, optionally, an I/O controller 308. These components may be in electronic communication or otherwise coupled (e.g., operatively, communicatively, functionally, electronically, electrically) via one or more interfaces (e.g., buses).

The processor 302, the memory 304, the transceiver 306, or various combinations thereof or various components thereof may be examples of means for performing various aspects of the present disclosure as described herein. For example, the processor 302, the memory 304, the transceiver 306, or various combinations or components thereof may support a method for performing one or more of the operations described herein.

In some implementations, the processor 302, the memory 304, the transceiver 306, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 302 and the memory 304 coupled with the processor 302 may be configured to perform one or more of the functions described herein (e.g., executing, by the processor 302, instructions stored in the memory 304).

For example, the processor 302 may support wireless communication at the device 300 in accordance with examples as disclosed herein. The processor 302 may be configured to operable to support a means for receiving, from the network entity 102, a configuration comprising information for evaluating validity of a resource for a small data transmission and determining the validity of the resource based on the information.

The processor 302 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 302 may be configured to operate a memory array using a memory controller. In some other implementations, a memory controller may be integrated into the processor 302. The processor 302 may be configured to execute computer-readable instructions stored in a memory (e.g., the memory 304) to cause the device 300 to perform various functions of the present disclosure.

The memory 304 may include random access memory (RAM) and read-only memory (ROM). The memory 304 may store computer-readable, computer-executable code including instructions that, when executed by the processor 302 cause the device 300 to perform various functions described herein. The code may be stored in a non-transitory computer-readable medium such as system memory or another type of memory. In some implementations, the code may not be directly executable by the processor 302 but may cause a computer (e.g., when compiled and executed) to perform functions described herein. In some implementations, the memory 304 may include, among other things, a basic I/O system (BIOS) which may control basic hardware or software operation such as the interaction with peripheral components or devices.

The I/O controller 308 may manage input and output signals for the device 300. The I/O controller 308 may also manage peripherals not integrated into the device 300. In some implementations, the I/O controller 308 may represent a physical connection or port to an external peripheral. In some implementations, the I/O controller 308 may utilize an operating system such as iOS®, ANDROID®, MS-WINDOWS®, OS/2®, UNIX®, LINUX®, or another known operating system. In some implementations, the I/O controller 308 may be implemented as part of a processor, such as the processor 306. In some implementations, a user may interact with the device 300 via the I/O controller 308 or via hardware components controlled by the I/O controller 308.

In some implementations, the device 300 may include a single antenna 310. However, in some other implementations, the device 300 may have more than one antenna 310 (i.e., multiple antennas), including multiple antenna panels or antenna arrays, which may be capable of concurrently transmitting or receiving multiple wireless transmissions. The transceiver 306 may communicate bi-directionally, via the one or more antennas 310, wired, or wireless links as described herein. For example, the transceiver 306 may represent a wireless transceiver and may communicate bi-directionally with another wireless transceiver. The transceiver 306 may also include a modem to modulate the packets, to provide the modulated packets to one or more antennas 310 for transmission, and to demodulate packets received from the one or more antennas 310. The transceiver 306 may include one or more transmit chains, one or more receive chains, or a combination thereof.

A transmit chain may be configured to generate and transmit signals (e.g., control information, data, packets). The transmit chain may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmit chain may also include at least one power amplifier configured to amplify the modulated signal to an appropriate power level suitable for transmission over the wireless medium. The transmit chain may also include one or more antennas 310 for transmitting the amplified signal into the air or wireless medium.

A receive chain may be configured to receive signals (e.g., control information, data, packets) over a wireless medium. For example, the receive chain may include one or more antennas 310 for receive the signal over the air or wireless medium. The receive chain may include at least one amplifier (e.g., a low-noise amplifier (LNA)) configured to amplify the received signal. The receive chain may include at least one demodulator configured to demodulate the receive signal and obtain the transmitted data by reversing the modulation technique applied during transmission of the signal. The receive chain may include at least one decoder for decoding the processing the demodulated signal to receive the transmitted data.

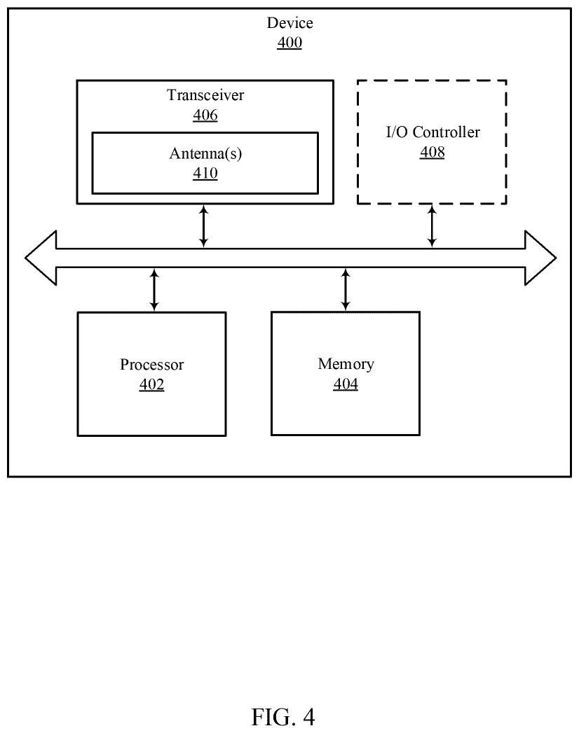

FIG. 4 illustrates an example of a device 400 that supports evaluation of a resource for SDT in accordance with aspects of the present disclosure. The device 400 may be an example of the network entity 102 as described herein. The device 400 may support wireless communication with one or more network entities 102, UEs 104, or any combination thereof. The device 400 may include components for bi-directional communications including components for transmitting and receiving communications, such as a processor 402, a memory 404, a transceiver 406, and, optionally, an I/O controller 408. These components may be in electronic communication or otherwise coupled (e.g., operatively, communicatively, functionally, electronically, electrically) via one or more interfaces (e.g., buses).

The processor 402, the memory 404, the transceiver 406, or various combinations thereof or various components thereof may be examples of means for performing various aspects of the present disclosure as described herein. For example, the processor 402, the memory 404, the transceiver 406, or various combinations or components thereof may support a method for performing one or more of the operations described herein.

In some implementations, the processor 402, the memory 404, the transceiver 406, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 402 and the memory 404 coupled with the processor 402 may be configured to perform one or more of the functions described herein (e.g., executing, by the processor 402, instructions stored in the memory 404).

For example, the processor 402 may support wireless communication at the device 400 in accordance with examples as disclosed herein. The processor 402 may be configured to operable to support a means for transmitting, to the UE 104, a configuration comprising information for evaluating validity of a resource for a small data transmission.

The processor 402 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 402 may be configured to operate a memory array using a memory controller. In some other implementations, a memory controller may be integrated into the processor 402. The processor 402 may be configured to execute computer-readable instructions stored in a memory (e.g., the memory 404) to cause the device 400 to perform various functions of the present disclosure.

The memory 404 may include random access memory (RAM) and read-only memory (ROM). The memory 404 may store computer-readable, computer-executable code including instructions that, when executed by the processor 402 cause the device 400 to perform various functions described herein. The code may be stored in a non-transitory computer-readable medium such as system memory or another type of memory. In some implementations, the code may not be directly executable by the processor 402 but may cause a computer (e.g., when compiled and executed) to perform functions described herein. In some implementations, the memory 404 may include, among other things, a basic I/O system (BIOS) which may control basic hardware or software operation such as the interaction with peripheral components or devices.

The I/O controller 408 may manage input and output signals for the device 400. The I/O controller 408 may also manage peripherals not integrated into the device 400. In some implementations, the I/O controller 408 may represent a physical connection or port to an external peripheral. In some implementations, the I/O controller 408 may utilize an operating system such as iOS®, ANDROID®, MS-WINDOWS®, OS/2®, UNIX®, LINUX®, or another known operating system. In some implementations, the I/O controller 408 may be implemented as part of a processor, such as the processor 406. In some implementations, a user may interact with the device 400 via the I/O controller 408 or via hardware components controlled by the I/O controller 408.

In some implementations, the device 400 may include a single antenna 410. However, in some other implementations, the device 400 may have more than one antenna 410 (i.e., multiple antennas), including multiple antenna panels or antenna arrays, which may be capable of concurrently transmitting or receiving multiple wireless transmissions. The transceiver 406 may communicate bi-directionally, via the one or more antennas 410, wired, or wireless links as described herein. For example, the transceiver 406 may represent a wireless transceiver and may communicate bi-directionally with another wireless transceiver. The transceiver 406 may also include a modem to modulate the packets, to provide the modulated packets to one or more antennas 410 for transmission, and to demodulate packets received from the one or more antennas 410. The transceiver 406 may include one or more transmit chains, one or more receive chains, or a combination thereof.

A transmit chain may be configured to generate and transmit signals (e.g., control information, data, packets). The transmit chain may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmit chain may also include at least one power amplifier configured to amplify the modulated signal to an appropriate power level suitable for transmission over the wireless medium. The transmit chain may also include one or more antennas 410 for transmitting the amplified signal into the air or wireless medium.

A receive chain may be configured to receive signals (e.g., control information, data, packets) over a wireless medium. For example, the receive chain may include one or more antennas 410 for receive the signal over the air or wireless medium. The receive chain may include at least one amplifier (e.g., a low-noise amplifier (LNA)) configured to amplify the received signal. The receive chain may include at least one demodulator configured to demodulate the receive signal and obtain the transmitted data by reversing the modulation technique applied during transmission of the signal. The receive chain may include at least one decoder for decoding the processing the demodulated signal to receive the transmitted data.

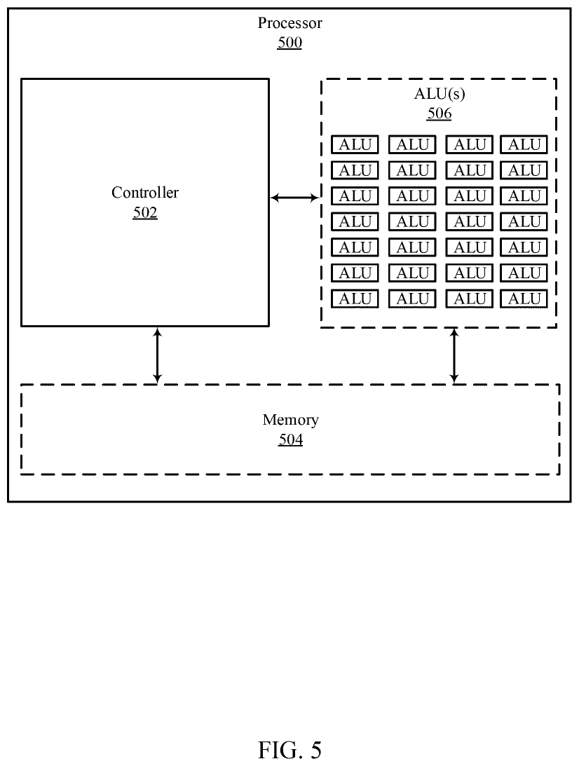

FIG. 5 illustrates an example of a processor 500 that supports evaluation of a resource for SDT in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, such as L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory address of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, arithmetic logic units (ALUs), and other functional units of the processor 500.

The memory 504 may include one or more caches (e.g., memory local to or included in the processor 500 or other memory, such RAM, ROM, DRAM, SDRAM, SRAM, MRAM, flash memory, etc. In some implementation, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, and the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementation, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to support a means for obtaining a configuration comprising information for evaluating validity of a resource for a small data transmission and determining the validity of the resource based on the information.

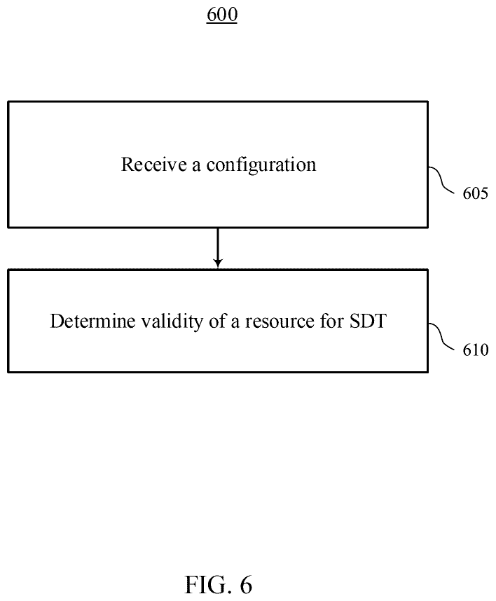

FIG. 6 illustrates a flowchart of a method 600 that supports evaluation of a resource for SDT in accordance with aspects of the present disclosure. The operations of the method 600 may be implemented by a device or its components as described herein. For example, the operations of the method 600 may be performed by the UE 104 as described herein. In some implementations, the device may execute a set of instructions to control the function elements of the device to perform the described functions. Additionally, or alternatively, the device may perform aspects of the described functions using special-purpose hardware.

At block 605, the method 600 may include receiving, from the network entity 102, a configuration comprising information for evaluating validity of a resource for SDT. The operations of 605 may be performed in accordance with examples as described herein. In some implementations, aspects of the operations of 605 may be performed by a device as described with reference to FIG. 1.

In some embodiments, the information may comprise at least one of the following: a set of radio bearers, an operation associated with network energy saving, a threshold for determination of the validity of the resource, or a reference value for determination of the validity of the resource.

In some embodiments, the threshold may be associated with at least one of the following: a radio bearer, a set of data radio bearers for the small data transmission, a set of signaling radio bearers for the small data transmission, a logic channel, or a logic channel group.

At block 610, the method 600 may include determining the validity of the resource based on the information. The operations of 610 may be performed in accordance with examples as described herein. In some implementations, aspects of the operations of 610 may be performed by a device as described with reference to FIG. 1.

In some embodiments, determining the validity of the resource may comprise determining a time interval between a first time point associated with the resource and a reference time point; in accordance with a determination that the time interval is below a threshold, determining that the resource is valid; and in accordance with a determination that the time interval is above the threshold, determining that the resource is invalid.

In some embodiments, the reference time point may be one of the following: a time point that a paging message associated with the small data transmission is received, a time point that a response to the paging message is initiated, a time point that a resume procedure is initiated for the small data transmission, or a time point that data associated with the small data transmission arrives.

In some embodiments, the threshold may be a latency requirement of a radio bearer in a set of radio bearers for the small data transmission.

In some embodiments, the information may comprise a set of thresholds associated with a set of radio bearers. In these embodiments, the method 600 may further include: receiving, from the network entity 102, a paging message comprising an indication of a radio bearer associated with the small data transmission in the set of radio bearers; and determining, from the set of thresholds, the threshold associated with the radio bearer.

In some embodiments, the threshold may be a timer value or a time window configured by the base station.

In some embodiments, the first time point may be a preamble transmission occasion associated with the resource. In some embodiments, the threshold may be a second time point associated with a configured grant resource for the small data transmission, the configured grant resource being invalid.

In some embodiments, the first time point may be determined based on an uplink data transmission occasion during a random access procedure. In some embodiments, the uplink data transmission occasion is determined based on a preamble transmission occasion associated with the resource and a reference value.

In some embodiments, the reference value may be determined based on at least one of the following: a random access response window, a round trip time value, a duration from reception of a downlink scheduling signal to reception of an uplink grant, a duration from transmission of a preamble to the reception of the downlink scheduling signal, or a processing delay.

In some embodiments, determining the validity of the resource may comprise at least one of the following: in accordance with a determination that the resource has no overlap with a duration in which no transmission or reception is performed by the base station, determining that the resource is valid; or in accordance with a determination that the resource overlaps with the duration in which no transmission or reception is performed by the base station, determining that the resource is invalid.

In some embodiments, determining the validity of the resource may comprise: determining an allowed uplink data transmission duration associated with a radio bearer in a set of radio bearers for the small data transmission; in accordance with a determination that an uplink data transmission duration associated with the resource is below the allowed uplink data transmission duration associated with the radio bearer, determining that the resource is valid; and in accordance with a determination that the uplink data transmission duration associated with the resource is above the allowed uplink data transmission duration associated with the radio bearer, determining that the resource is invalid.

In some embodiments, the method 600 may further comprise: selecting a first carrier for initiating the small data transmission; and in accordance with a determination that no resources on the first carrier are valid and a resource on a second carrier is valid, performing a carrier reselection to the second carrier.

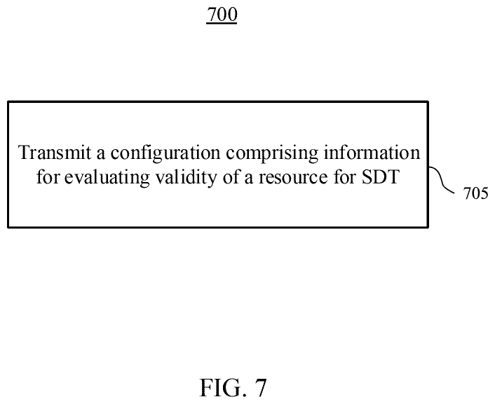

FIG. 7 illustrates a flowchart of another method 700 that supports evaluation of a resource for SDT in accordance with aspects of the present disclosure. The operations of the method 700 may be implemented by a device or its components as described herein. For example, the operations of the method 700 may be performed by the network entity 102 as described herein. In some implementations, the device may execute a set of instructions to control the function elements of the device to perform the described functions. Additionally, or alternatively, the device may perform aspects of the described functions using special-purpose hardware.

At block 705, the method 700 may include transmitting, to the UE 104, a configuration comprising information for evaluating validity of a resource for a small data transmission. The operations of 705 may be performed in accordance with examples as described herein. In some implementations, aspects of the operations of 705 may be performed by a device as described with reference to FIG. 1.

In some embodiments, the information may comprise at least one of the following: a set of radio bearers, an operation associated with network energy saving, a threshold for determination of the validity of the resource, or a reference value for determination of the validity of the resource.

In some embodiments, the threshold may be associated with at least one of the following: a radio bearer, a set of data radio bearers for the small data transmission, a set of signaling radio bearers for the small data transmission, a logic channel, or a logic channel group.

In some embodiments, the threshold may be a timer value or a time window configured by the base station.

In some embodiments, the information may comprise a set of thresholds associated with a set of radio bearers. In these embodiments, the method 700 may further include: transmitting, to the UE 104, a paging message comprising an indication of a radio bearer associated with the small data transmission in the set of radio bearers.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive, from a base station, a configuration comprising information for evaluating a validity of a resource for a small data transmission; and
determine the validity of the resource based on the information.

2. The user UE of claim 1, wherein the information comprises:
a set of radio bearers,
an operation associated with network energy saving,
a threshold for determination of the validity of the resource, or
a reference value for determination of the validity of the resource.

3. The UE of claim 2, wherein the threshold is associated with:
a radio bearer,
a set of data radio bearers for the small data transmission,
a set of signaling radio bearers for the small data transmission,
a logic channel, or
a logic channel group.

4. The UE of claim 1, wherein, to determine the validity of the resource, the at least one processor is configured to cause the UE to:
determine a time interval between a first time point associated with the resource and a reference time point;
determine that the resource is valid when the time interval is below a threshold.

5. The UE of claim 4, wherein the reference time point is:
a point in time when a paging message associated with the small data transmission is received,
a point in time when a response to the paging message is initiated,
a point in time when a resume procedure is initiated for the small data transmission, or
a point in time when data associated with the small data transmission arrives.

6. The UE of claim 4, wherein the threshold is a latency requirement of a radio bearer in a set of radio bearers for the small data transmission.

7. The UE of claim 4, wherein the information comprises a set of thresholds associated with a set of radio bearers, and wherein the at least one processor is further configured to cause the UE to:
receive, from the base station, a paging message comprising an indication of a radio bearer associated with the small data transmission in the set of radio bearers; and
determine, from the set of thresholds, the threshold associated with the radio bearer.

8. The UE of claim 4, wherein the threshold is a timer value or a time window configured by the base station.

9. The UE of claim 4, wherein the first time point is a preamble transmission occasion associated with the resource.

10. The UE of claim 9, wherein the threshold is a second time point associated with an invalid configured grant resource for the small data transmission.

11. The UE of claim 4, wherein the first time point is determined based on an uplink data transmission occasion during a random access procedure.

12. The UE of claim 11, wherein the uplink data transmission occasion is determined based on a preamble transmission occasion associated with the resource and a reference value.

13. The UE of claim 12, wherein the reference value is determined based on:
a random access response window,
a round trip time value,
a duration from reception of a downlink scheduling signal to reception of an uplink grant,
a duration from transmission of a preamble to the reception of the downlink scheduling signal, or
a processing delay.

14. The UE of claim 1, wherein, to determine the validity of the resource, the at least one processor is configured to cause the UE to:
when the resource has no overlap with a duration in which no transmission or reception is performed by the base station, determine that the resource is valid; or
when the resource overlaps with the duration in which no transmission or reception is performed by the base station, determine that the resource is invalid.

15. The UE of claim 1, wherein, to determine the validity of the resource, the at least one processor is configured to cause the UE to:
determine an allowed uplink data transmission duration associated with a radio bearer in a set of radio bearers for the small data transmission;
when an uplink data transmission duration associated with the resource is below the allowed uplink data transmission duration associated with the radio bearer, determine that the resource is valid; and
when the uplink data transmission duration associated with the resource is above the allowed uplink data transmission duration associated with the radio bearer, determine that the resource is invalid.

16. The UE of claim 1, wherein the at least one processor is further configured to cause the UE to:
select a first carrier for initiating the small data transmission; and
when no resources on the first carrier are valid and a resource on a second carrier is valid, perform a carrier reselection to the second carrier.

17. A processor for wireless communication, comprising:
at least one memory; and
at least one controller coupled with the at least one memory and configured to cause the processor to:
obtain a configuration comprising information for evaluating validity of a resource for a small data transmission; and
determine the validity of the resource based on the information.

18. A base station for wireless communication, comprising:
at least one memory; and
at least one processor coupled with the at least one memory and configured to cause the base station to:
transmit, to a user equipment (UE), a configuration comprising information for evaluating validity of a resource for a small data transmission.

19. (canceled)

20. A method performed by a user equipment (UE), the method comprising:
receiving, from a base station, a configuration comprising information for evaluating validity of a resource for a small data transmission; and
determining the validity of the resource based on the information.

21. The method of claim 20, wherein determining the validity of the resource includes:
determining a time interval between a first time point associated with the resource and a reference time point;
determining that the resource is valid when the time interval is below a threshold.
